(19) United States
(12) Patent Application Publication
(10) Pub. No.: US 2021/0334843 A1
(43) Pub. Date: Oct. 28, 2021

(54) AUTOMATICALLY EMBEDDING DIGITAL DATA IN A MESSAGE AND CAPTURING ANALYTICS FOR THE DIGITAL DATA

(71) Applicant: salesforce.com, inc., San Francisco, CA (US)

(72) Inventors: Eric Paul Wittke, Chicago, IL (US); Rick Muñoz, Oakland, CA (US); Derek Payne, Greenwood, IN (US); Donald Owens, Indianapolis, IN (US); Jason Day, Fortville, IN (US); Kasia Fichtner, Moraga, CA (US); Vineeth Anand Nair, Mountain House, CA (US)

(73) Assignee: salesforce.com, inc., San Francisco, CA (US)

(21) Appl. No.: 16/860,748

(22) Filed: Apr. 28, 2020

(51) Int. Cl. G06Q 30/02; G06F 16/958; G06F 16/901

(52) U.S. Cl. CPC G06Q 30/0243; G06Q 30/0202; G06F 16/9024; G06F 16/958; G06Q 30/0201

(57) ABSTRACT

Provided herein are system, apparatus, device, method and/or computer program product embodiments, and/or combinations and sub-combinations thereof for automatically embedding digital data in a message and capturing analytics for the digital data. In some embodiments, a server may retrieve information about a user. The server may execute a predictive analysis on the information about the user to identify digital data to be transmitted to the user. The digital data may include an embedded tag associated with an object. The server may automatically embed the identified digital data in a messaging prompt to be transmitted to the user. The server may identify the object associated with the embedded tag, using the embedded tag. The server may determine interaction data for the object and digital data and render the interaction data on a user interface.

### BACKGROUND

Marketers have limited ways to compare variations of the same dynamic content. Conventional systems are limited to A/B testing. A/B is a method of comparing two versions of digital content against each other to determine which one performs better. However, conventional systems do not provide simultaneously testing numerous versions of digital content.

### BRIEF DESCRIPTION OF THE DRAWINGS

The accompanying drawings, which are incorporated herein and form a part of the specification, illustrate the embodiments of the present disclosure, and together with the description, further serve to explain the principles of the embodiments and enable a person skilled in the pertinent art to make and use the embodiments, individually, or as a combination thereof.

FIG. 1 is a block diagram of an example environment in which systems and/or methods described herein may be implemented, according to some embodiments.

FIG. 2 illustrates sample emails including digital data, according to some embodiments.

FIG. 3 is a screen rendered on a user interface including analytics data related to digital data, according to some embodiments.

FIG. 4 is a screen rendered on a user interface including settings of the digital data, according to some embodiments.

FIG. 5 is a screen rendered on a user interface including analytics data of objects, according to some embodiments.

FIG. 6 is a screen rendered on a user interface including prediction information about a segment of users, according to some embodiments.

FIG. 7 is a flowchart illustrating a process of embedding digital data in a message and rendering analytics data about digital data, according to some embodiments.

FIG. 8 is a flowchart illustrating a process of including and removing analytics data from the user interface for objects or digital data, according to some embodiments.

FIG. 9 is a flowchart illustrating a process of determining and rendering analytics information about a segment of users as the segment is being generated, according to some embodiments.

FIG. 10 is a block diagram of example components of a computing system, according to some embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof for automatically embedding digital data in a message and capturing analytics for the digital data. This enables users to simultaneously test numerous versions of digital content.

In some embodiments, a server may retrieve information about a user. The server may execute a predictive analysis on the information about the user to identify digital data to be transmitted to the user. The server may identify the digital data to be transmitted to the user based on the predictive analysis. The digital data may include an embedded tag associated with an object. The server may automatically embed the identified digital data in a messaging prompt to be transmitted to the user. The server may identify the object associated with the embedded tag, using the embedded tag. The server may determine interaction data for the object and digital data and render the interaction data on a user interface.

Embodiments herein can identify the most accurate digital data to be presented to a user based on the predictive analysis of the user information. Furthermore, the embodiments present analytics about the object and digital data on a user interface. This configuration allows for A/Bₙ testing. The embodiments can enable a user to view the viability of the various options of digital data along with the objects associated with the digital data. In this regard, the embodiments solve the technical problem of being able to receive and present analytics about digital data and objects in (near) real-time.

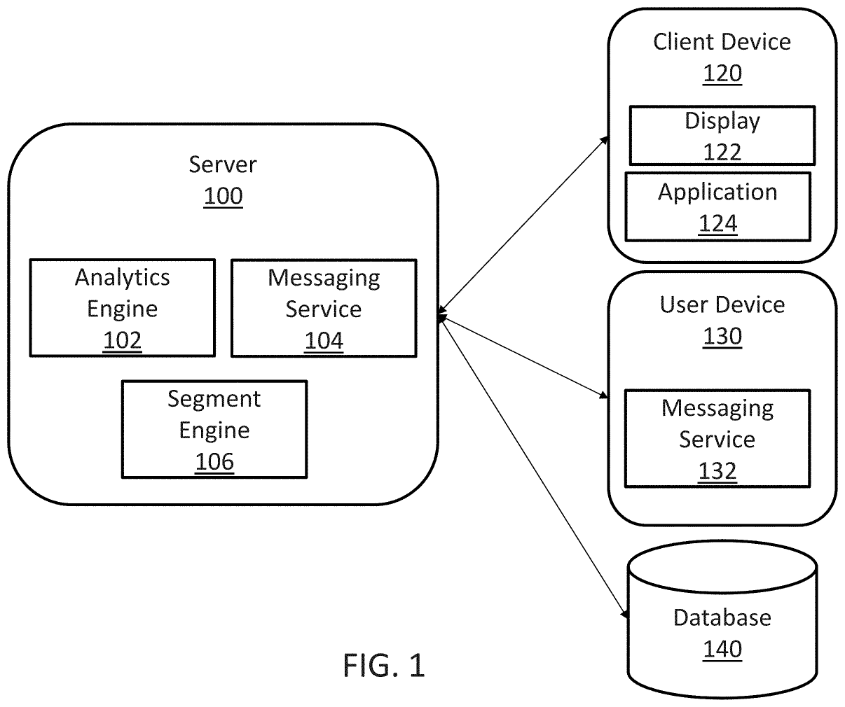

FIG. 1 is a block diagram of a system for automatically embedding digital data in a message and capturing analytics for the digital data, according to some embodiments. The system includes the server 100, the client device 120, user device 130, and database 140. The devices of the environment may be connected through wired connections, wireless connections, or a combination of wired and wireless connections.

In some embodiments, the server 100, the client device 120, user device 130, and database 140 may be connected through a network. One or more portions of the network may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The server 100 may include an analytics engine 102, a messaging service 104, and a segment engine 106. The server 100 and the analytics engine 102, messaging service 104, and segment engine 106 may reside in a cloud computing environment. Alternatively, the server 100 may reside outside the cloud computing environment and the analytics engine 102, messaging service 104, and segment engine 106 may be executed in the cloud computing environment. In some other embodiments, the server and the analytics engine 102, messaging service 104, and segment engine 106 may reside outside the cloud computing environment.

The client device 120 may be configured to render a user interface on a display 122. The client device 120 may interface with the server 100 using application 124. The application 124 may reside in the cloud computing environment or locally on the client device 120. In some other embodiments, the application 124 may be a web-based application, accessible through a website.

The user device 130 includes a messaging service 132. The messaging service 132 may be a messaging platform such as e-mail, instant messaging, short message service (SMS), Multimedia Messaging Service (MMS), iMessage®, or the like. The user device 130 may receive communication from the server 100 through the messaging service 132.

In some other embodiments, a message may be initiated that is intended to be delivered to a user or a group (e.g., segment) of users using the messaging service 104. The messaging service 104 may be a messaging platform configured to transmit messages to messaging service 132. The messaging service 104 may be e-mail, instant messaging, short message service (SMS), Multimedia Messaging Service (MMS), iMessage®, or the like. To initiate the message to the users or segment of users, a user identifier of each user may be input in the message. The user identifier may be an email address, phone number, screen name, or some other type of identifier as would be appreciated by a person of ordinary skill in the art. The message is intended to include digital data.

The analytics engine 102 may detect the user identifier input in the message and may search the database 140 for historical information related to the user. The historical information may include user preferences regarding objects, products, activities, vacations, or some other type of preference as would be appreciated by a person of ordinary skill in the art. The analytics engine 102 may execute a predictive analysis on the retrieved historical data to identify the digital data to be included in the message to the user. The analytics engine 102 identifies the digital data based on a likelihood that the user will interact with the digital data. In response to identifying the digital data to be included in the message to the user, the analytics engine 102 may automatically populate the message to embed the identified digital data in the message.

In the event that the message is being transmitted to a group or segment of users, the analytics engine 102 may retrieve historical data for all or a portion of the users in the group or segment. The analytics engine 102 may execute a predictive analysis on the retrieved historical data for all or a portion of the users in the group or segment to identify the digital data to be included in the message to the group or segment. The analytics engine 102 may identify the digital data based on the likelihood of the group or segment to interact with the digital data. Digital data may be digital content such as images, videos, text, or the like.

The digital data may be embedded with a link and a tag associated with an object. The link may be to a website that includes the information about the object and a link to a website including the tagged object. In some other embodiments, the digital data may be embedded with multiple tags associated with various objects.

The message may be transmitted to the user device(s) 130. The user device(s) 130 may receive the message using the messaging service 132. The server 100 may capture data associated with interactions with the digital data. As described above, the digital data may include a link to a website. A user may interact with the digital data through clicks and impressions. Clicks can be a total number of times the digital data was clicked. In this regard, the server 100 may capture the number of times a user(s) actuated the link embedded in the digital data. Impressions can be a total number of times information related to the digital data is displayed on the user device 130. Impression data may include a number of times users opened an email including the digital data or the number of times the user navigated to the website by selecting the link embedded in the digital data.

As described above, the digital data may be embedded with a link to a website and the website may include information about the tagged object and a link to a website including the tagged object. The server 100 may capture associated with interactions with the tagged object. The interaction data may include clicks and impressions. The clicks may be associated with a total amount of clicks of the links directed to the website including the tagged objects. Impressions may be a total number of times the website including the tagged object is displayed on the user device 130.

The client device 120 may interface the server 100 using the application 124. The application 124 may transmit a request to the server 100 to view analytics data of the digital data and the object. The analytics engine 102 may generate analytics data using the captured interaction data. The analytics engine 102 may render the analytics data for the object and the digital data on a user interface. The analytics engine 102 may render the user interface on the user device's display 122 using application 124.

In some other embodiments, the digital data may be embedded with tags for various objects. The server 100 may capture the interaction data associated with the various objects. The analytics engine 102 may generate analytics data using the captured interaction data and render the analytics data on the user interface. The analytics engine 102 may render the user interface on the user device's display 122 using application 124.

The client device 120 may receive input associated with the selection of the objects displayed on the user interface. In response to selecting an object on the user interface, the analytics engine 102 may render the analytics information regarding the selected object on the user interface. In response to unselecting an object, the analytics engine 102 may remove the analytics information from the user interface.

The analytics engine 102 may also render analytics information for different types of digital data. For example, different types of digital data may be transmitted to different users (e.g., based on predictive analysis). The analytics engine 102 may render the analytics data for the different types of digital data on the user interface. The client device 120 may receive input associated with the selection of the digital data. In response to the selection of a type of digital data, the analytics data for the type of digital data may be displayed on the user interface. In response to unselecting the type of digital data, the analytics for the type of digital data may be removed from the user interface.

In some other embodiments, the client device 120 may use application 124 to interface with server 100. The client device 120 may use application 124 to generate segments of users for transmitting digital data. The client device 120 interfaces with the segment engine 106 to generate the segment of users. The segment engine 106 may render a user interface on the display 122 of the client device using the application 124.

The client device 120 may receive input for selecting users to include in the segments. In response to being included in a segment, the analytics engine 102 may retrieve information about the users from the database 140. The information may include user preference information regarding objects, products, activities, vacations, or other types of preferences as would be appreciated by a person of ordinary skill in the art. The analytics engine 102 may execute a predictive analysis on the segment as the users are input in the segment (e.g., in near real-time).

The analytics engine 102 may provide prediction information indicating the viability of the segment. For example, the segment of users may be sent the same digital data. The prediction information may indicate whether a given amount of the group is likely to interact with the same digital data. The analytics engine 102 may update and provide the prediction information as users are included and removed from the segment. This allows for an operator of the client device 120 to receive live feedback regarding a segment.

In some other embodiments, the analytics engine 102 may generate suggestions about narrowing down the segment to a given set of users based on the predictive analysis executed on the segment. This allows for a larger percentage of the segment to interact with the digital data. The suggestions may be rendered on the user interface.

The prediction information may include a frequency analysis, email click prediction, email open prediction, email unsubscribe prediction, send time optimization, and content audit. The frequency analysis may determine the optimal frequency at which a segment can receive digital data. Email click prediction may be a prediction of the likelihood a given number of users in the segment may click on digital data in an email. Email open prediction may be a prediction of the likelihood a given number of users in the segment may open an email. Email unsubscribe prediction may be a prediction of the likelihood that a given number of users in the segment may unsubscribe to an email. Send time optimization may provide an optimal time of day to send digital data to the users of the segment so that users of the segment interact with the digital data. Content audit may include a suggestion of content to be transmitted to the users of the segment

As a non-limiting example, the digital data may be advertisements and users may be potential customers. The advertisements may be embedded with a link to a website and tags for products. The link may be to a website that includes links to the e-commerce websites selling the tagged products.

A message may be initiated that is intended to be delivered to a user using the messaging service 104. To initiate the message to the user, a user identifier of the user may be input in the message.

The analytics engine 102 may detect the user identifier input in the message and may search the database 140 for historical information related to the user. The historical information may include user preferences regarding objects, products, activities, vacations, or other types of preferences as would be appreciated by a person of ordinary skill in the art. The historical information may also include the user's purchase history. The analytics engine 102 may also retrieve historical information about products tagged in the advertisement. The historical information about the products may include the purchase history of the products and the types of users purchasing the products.

The analytics engine 102 may execute a predictive analysis on the retrieved historical data for the user and the tagged products, to identify a particular advertisement to be included in the message to the user. The analytics engine 102 identifies the advertisement based on a likelihood that the user will interact with the digital data. In response to identifying the digital data to be included in the message to the user, the analytics engine 102 may automatically populate the message to embed the identified advertisement in the message.

The message may be transmitted to the user device 130. The user device 130 may receive the message using the messaging service 132. The server 100 may capture interaction data associated with the advertisement transmitted to the user. As described above, the advertisement may include a link to a website. A user may interact with the advertisement through clicks and impressions.

As described above, the advertisement may be embedded with a link to a website and the website may include a link to an e-commerce website selling the tagged products. The server 100 may capture interaction data associated with the tagged products. The interaction data may include clicks and impressions.

Different advertisements may be transmitted to different users. Furthermore, various tags for products may be embedded in the advertisement. Each advertisement may include the same or different tagged products.

The client device 120 may interface the server 100 using the application 124. The application 124 may transmit a request to the server 100 to view analytics data of the advertisements and products. The analytics engine 102 may generate analytics data using the captured interaction data. The analytics engine 102 may render the analytics data for the advertisement and products on a user interface. The analytics engine 102 may render the user interface on the user device's display 122 using application 124.

The client device 120 may receive input associated with the selection of products tagged in various advertisements, displayed on the user interface. In response to selecting a product on the user interface, the analytics engine 102 may render the analytics information regarding the selected product on the user interface. In response to unselecting a product, the analytics engine 102 may remove the analytics information from the user interface.

The analytics engine 102 may also render analytics information for different advertisements. For example, different advertisements may be transmitted to different users (e.g., based on predictive analysis). The analytics engine 102 may render the analytics data for the different advertisements on the user interface. The client device 120 may receive input associated with the selection of the advertisement. In response to the selection of a particular advertisement, the analytics data for the particular advertisement may be displayed on the user interface. In response to unselecting the particular advertisement, the analytics for the particular advertisement may be removed from the user interface.

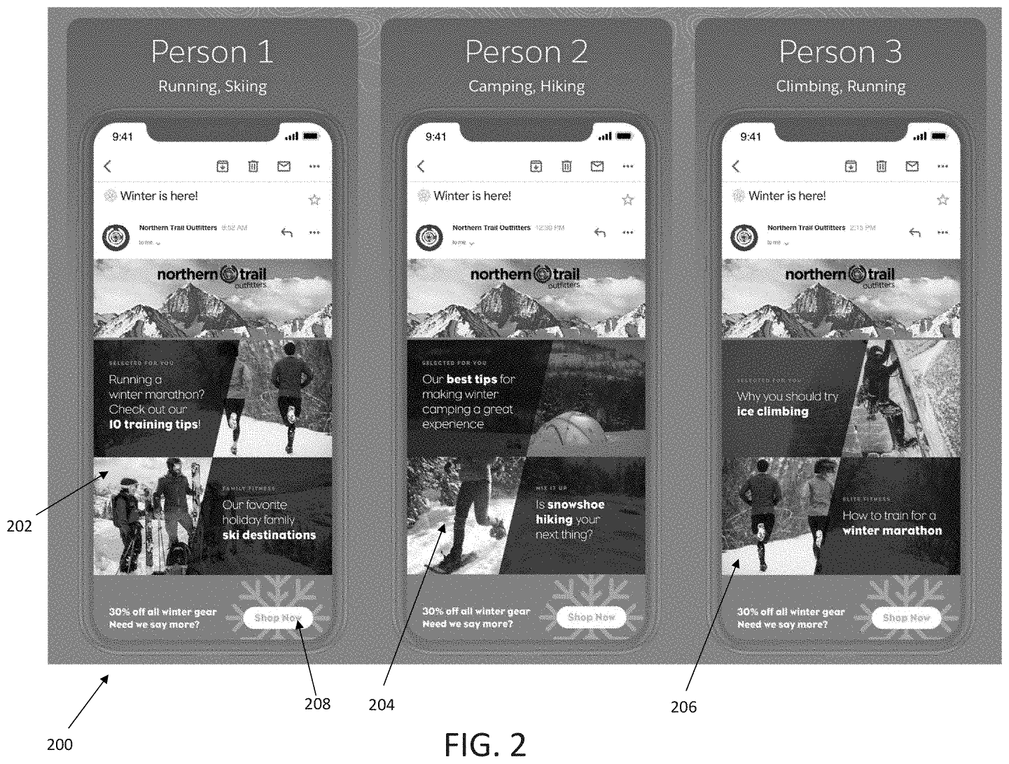

FIG. 2 illustrates sample emails to be transmitted to users including digital data according to some embodiments. In some embodiments, digital data such as advertisements may be embedded in messages, such as emails, and transmitted to users. As shown in FIG. 2, message 202 is an email received by Person 1, message 204 is an email received by Person 2, and message 206 is an email received by Person 3.

As described above, the analytics engine executes a predictive analysis on a user's information to identify advertisements that may interest the user and the user is likely to interact with. Message 202 includes an advertisement for running and skiing products. The analytics engine 102 may determine that Person 1 is interested in running and skiing based on the predictive analysis. The advertisement may have been automatically embedded in the email directed to Person 1, in response to determining that Person 1 is interested in running and skiing.

Message 204 includes an advertisement for camping and hiking products. The analytics engine may determine that Person 2 is interested in camping and hiking based on the predictive analysis. The advertisement may have been automatically embedded in the email directed to Person 2, in response to determining that Person 2 is interested in camping and hiking.

Message 206 includes an advertisement for climbing and running products. The analytics engine may determine that Person 3 is interested in climbing and running based on the predictive analysis. The advertisement may have been automatically embedded in the email directed to Person 3, in response to determining that Person 3 is interested in climbing and running.

Each of the messages 202-206 may include a link 208. The link 208 may direct a user to a website that includes information about tagged objects/products for sale. The website may further include links to purchase the products for sale on e-commerce websites. The tagged objects/products for sale may be associated with the respective advertisement. For example, the advertisement for running and skiing may be tagged with running and skiing products for sale. The advertisement for camping and hiking may be tagged with products associated with camping and hiking. The advertisement for climbing and running may be tagged with products associated with climbing and running.

The different advertisements may include digital content such as images and texts. The advertisements may be stored in a database (e.g., database 140 as shown in FIG. 1). The analytics engine may execute source code to automatically retrieve the respective advertisement from the database based on the results of the predictive analysis and embed the advertisement in the respective message.

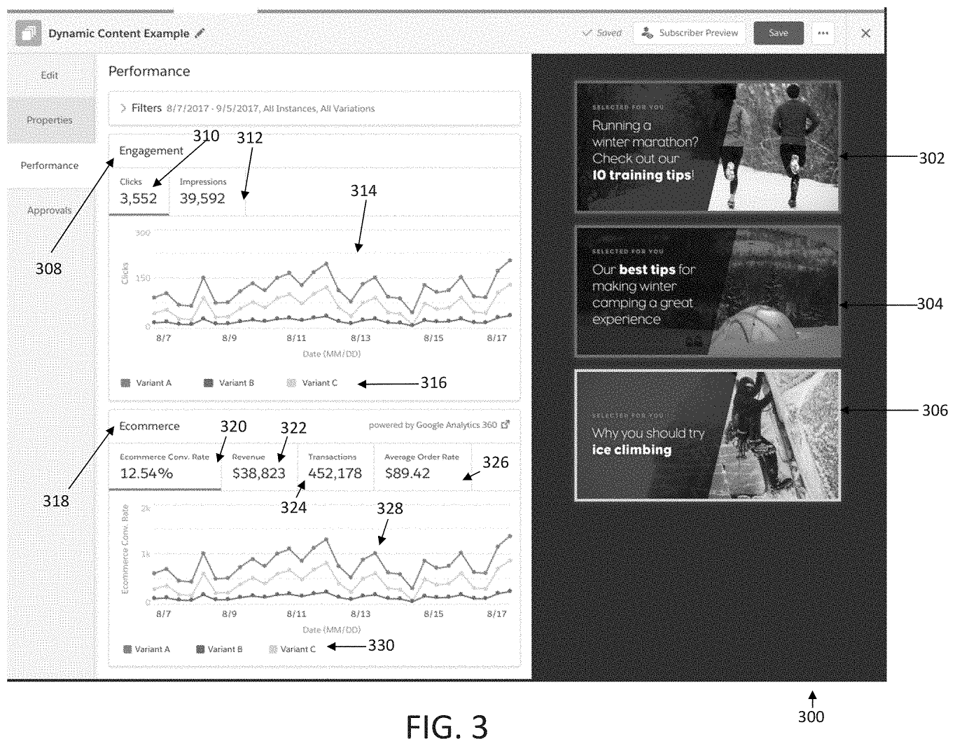

FIG. 3 is a screen 300 rendered on a user interface including analytics data related to digital data, according to some embodiments. Screen 300 may be part of the user interface presented to a user of the client device (e.g., client device 120) when interacting with an application (e.g., application 124). The screen 300 may display different types of digital data such as advertisement 302, 304, and 306. Each of the advertisements may have been transmitted to different users. Advertisement 302 may be directed to running, advertisement 304 may be directed to camping, and advertisement 306 may be directed to climbing. Images of advertisements 302-306 may be rendered on the right side of the user interface.

The screen 300 may include an engagement analytics section 308 and an e-commerce section 318. The engagement analytics section 308 may include a clicks tab 310 and an impressions tab 312. The engagement analytics section 308 may also include a graph depicting the analytics of the clicks or impressions of advertisements 302-306. In the event, the clicks tab 310 is selected graph 314 depicts analytics of the clicks of advertisements 302-306. In the event, the impressions tab 312 is selected, graph 314 depicts the analytics of the impressions of advertisements 302-306. The x-axis of the graph 314 may be a date range and the y-axis may be clicks or impressions based on the selected tab. A total amount of clicks may be displayed under the clicks tab 310 and a total amount of impressions may be displayed under the impressions tab 312.

A list of the advertisements 316 for which analytics information is included on the graph 314 may be rendered below the x-axis. A user may include or remove analytics data about advertisements 302-306 to and from graph 314 by selecting or unselecting, the images of the advertisements 302-306 displayed on the right of the screen 300.

The e-commerce section 318 may include an e-commerce conversion rate tab 320, revenue rate tab 322, transactions tab 324, and average order rate tab 326. The e-commerce section 318 may further include a graph 328. The graph 328 may depict analytics data for each respective tab (e.g., e-commerce conversion rate tab 320, revenue rate tab 322, transactions tab 324, or average order rate tab 326). The x-axis may be a date range and the y-axis may be e-commerce conversion rate tab 320, revenue rate tab 322, transactions tab 324, or average order rate tab 326, based on the selected tab.

A list of the advertisements 330 for which analytics information is included on the graph 328 may be rendered below the x-axis. A user may include or remove analytics data about advertisements 302-306 to and from graph 328 by selecting or unselecting, the images of the advertisements 306-306 displayed on the right of the screen 306.

The analytics information on screen 300 provides a user with information related to the effectiveness of the different types of advertisements. The screen 300 may display analytics data of n number of products. A user can compare the analytics data for the different products and compare the effectiveness of each of the advertisements for the products over a period of time. This provides the user with the ability of A/Bₙ testing.

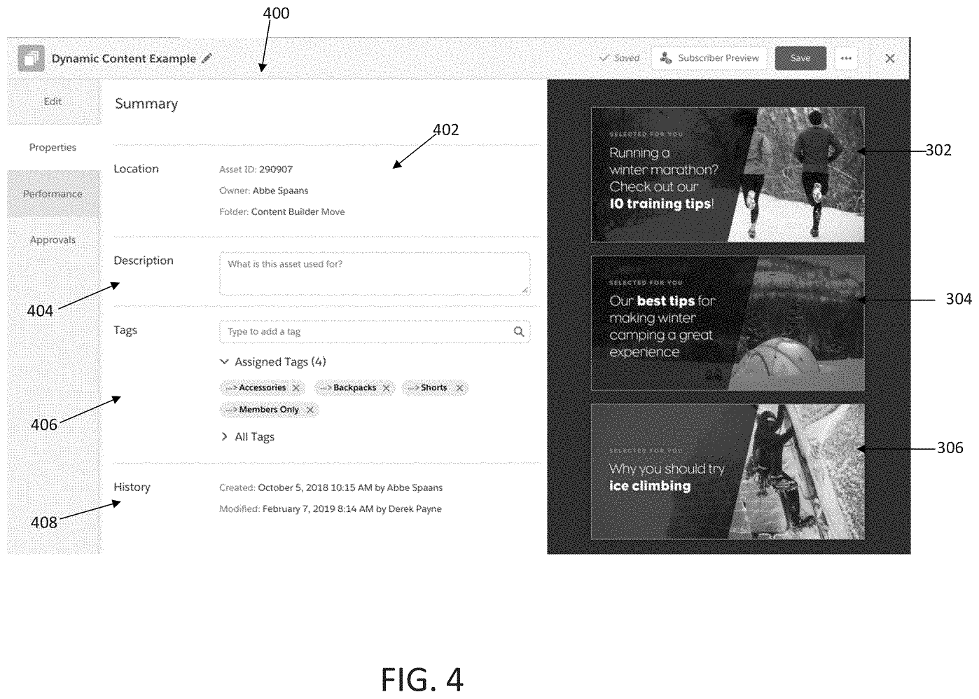

FIG. 4 is a screen 400 rendered on a user interface including properties of the digital data, according to some embodiments. Screen 400 may be part of the user interface presented to a user of the client device (e.g., client device 120) when interacting with an application (e.g., application 124). Screen 400 may include images of digital data such as advertisements 302-306. The images of the advertisements 302-306 may be displayed on the right side of the screen 400. The screen 400 may further include a location section 402, a description section 404, a tags section 406, and a history section 408.

The location section 402 may include an asset ID (e.g., advertisement ID), owner, and folder in which the advertisement is located. The location information may indicate where the file of the advertisement can be located in a data storage device or file system.

The description section 404 may include a description of the advertisement. The description may include the products depicted/advertised in the advertisement.

The tags section 406 may include a list of all the products tagged in the respective advertisements. The tags section 406 may be used to add or remove tags for an advertisement. A user may add a product to the tagged products by inputting a tagged product in an input box included in the tags section 406. The tagged products may be removed by selecting the ‘x’ button for each respective tagged product. The tags section 406 may further include assigned tags and all tags. The assigned tags may be the products tagged for the advertisements. All tags may be all the available tags. The assigned tags may be embedded in the advertisement so that when the link of the advertisement is selected, the user is directed to a website including information about the tagged products.

The history section 408 may include a history of the advertisement. The history may include when the advertisement was created and modified.

A user can view the properties of a particular advertisement by selecting one of the images of the advertisements 302-306 displayed on the right of screen 400. Any changes to the properties may be saved. A preview of the advertisement may also be displayed on screen 400.

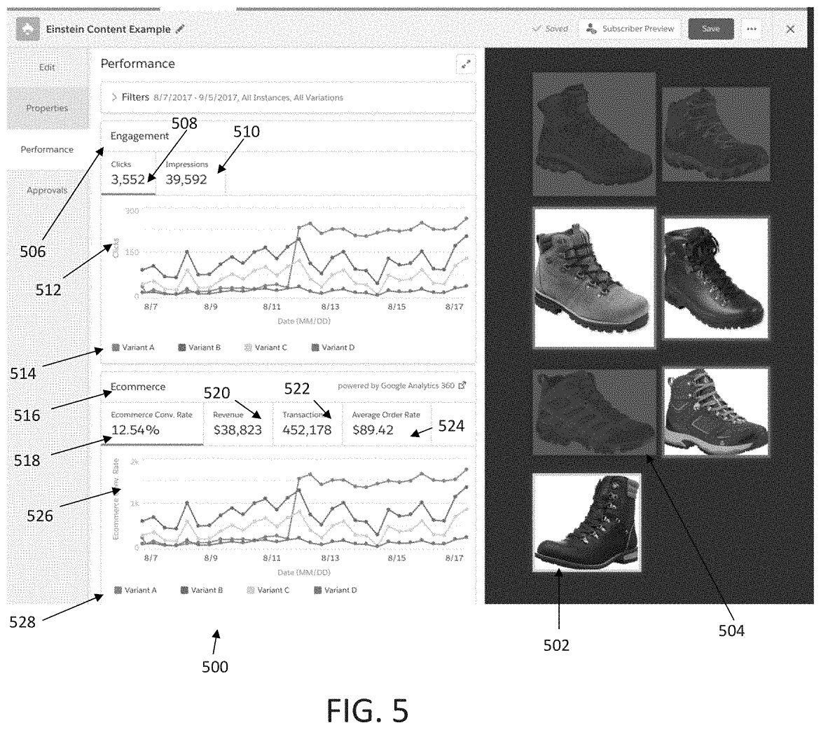

FIG. 5 is a screen 500 rendered on a user interface including analytics data of objects according to some embodiments. Screen 500 may be part of the user interface presented to a user of the client device (e.g., client device 120) when interacting with an application (e.g., application 124). Screen 500 may include objects such as products for sale which are tagged in advertisements. For example, screen 500 may include images of different types of products available for sale. The images may be displayed on the right sight of the screen. Certain products may be selected products 502. Other products may be unselected products 504. Analytics information about the selected products 502 may be displayed on-screen 500. A user may remove or add analytics information about a product by selecting or unselecting a product. The images corresponding to the unselected products 504 may be greyed out.

The screen 500 may include an engagement analytics section 506 and an e-commerce section 516. The engagement analytics section 506 may include a clicks tab 508 and an impressions tab 510. The engagement analytics section 506 may also include a graph depicting the analytics of the clicks or impressions of advertisements the selected products 502. In the event, the clicks tab 508 is selected, graph 512 depicts the analytics of the clicks of advertisements 302-306. In the event, the impressions tab 510 is selected, graph 512 depicts the analytics of the impressions of the selected products 502. The x-axis of the graph 512 may be a date range and the y-axis may be clicks or impressions based on the selected tab. A total amount of clicks may be displayed under the clicks tab 508 and a total amount of impressions may be displayed under the impressions tab 510.

A list of the advertisements 514 for which analytics information is included on the graph 514 may be rendered below the x-axis. A user may include or remove analytics data about selected products 504 to and from the graph 514 by selecting or unselecting the images of the selected products 502 or unselected products 504 displayed on the right of the screen 500.

The e-commerce section 516 may include an e-commerce conversion rate tab 518, revenue rate tab 520, transactions tab 522, and average order rate tab 524. The e-commerce section 516 may further include a graph 526. The graph 536 may depict analytics data for each respective tab (e.g., e-commerce conversion rate tab 518, revenue rate tab 520, transactions tab 520, or average order rate tab 524). The x-axis may be a date range and the y-axis may be e-commerce conversion rate tab 518, revenue rate tab 520, transactions tab 522, or average order rate tab 524, based on the selected tab.

A list of the advertisements 528 for which analytics information is included on the graph 526 may be rendered below the x-axis. A user may include or remove analytics data about selected products 504 to and from the graph 526 by selecting or unselecting the images of the selected products 502 or unselected products 504 displayed on the right of the screen 500.

The analytics information on screen 500 provides a user with information related to the effectiveness of the different types of advertisements for different products. The screen 500 may display analytics data of n number of objects. A user can compare the analytics data for the different advertisements and compare the effectiveness of each of the advertisements for different products over a period of time. This provides the user with the ability of A/Bₙ testing.

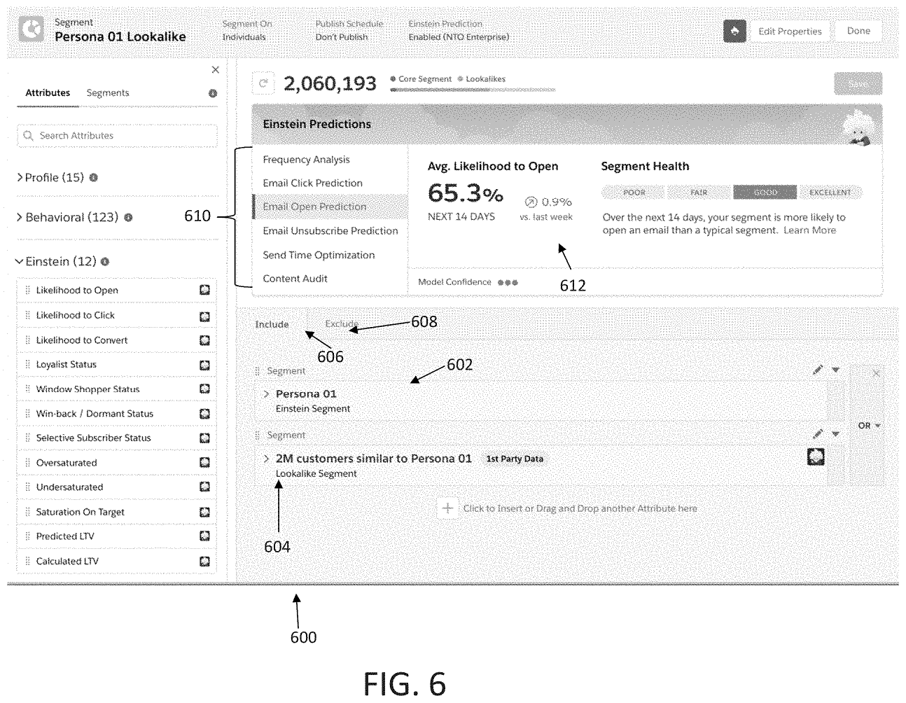

FIG. 6 is a screen 600 rendered on a user interface including prediction information about a segment of users, according to some embodiments. Screen 600 may be part of the user interface presented to a user of the client device (e.g., client device 120) when interacting with an application (e.g., application 124). Screen 600 may include segment 602 and 604, an include tab 606, an exclude tab 608, prediction categories 610, and prediction information for the respective category.

In some other embodiments, a user may interface with screen 600 to create a segment of users. The segment of users may receive the same type of digital data. That is, the segment of users may receive the same type of advertisements. A segment may be automatically generated using predictive algorithms. Alternatively, a segment may be manually generated by adding users to the segment.

As an example, a user may add users to segment 602. As users are added to segment 602, the prediction information is updated in (near) real-time. An analytics engine may execute a predictive analysis on the segment to determine the likelihood that each user is likely to interact with similar types of advertisements.

The categories may include a frequency analysis, email click prediction, email open prediction, email unsubscribe prediction, send time optimization, and content audit. The frequency analysis may determine the optimal frequency at which a segment can receive digital data. Email click prediction may be a prediction of the likelihood a given number of users in the segment may click on digital data in an email. Email open prediction may be a prediction of the likelihood a given number of users in the segment may open an email. Email unsubscribe prediction may be a prediction of the likelihood that a given number of users in the segment may unsubscribe to an email. Send time optimization may provide an optimal time of day to send digital data to the users of the segment so that users of the segment interact with the digital data. Content audit may include a suggestion of content to be transmitted to the users of the segment.

The prediction information 612 may be displayed for each category, depending on which category is selected. For example, the prediction information 612 for the email open prediction category may include an average likelihood to open an email including the advertisement, segment health, and the model confidence. The average likelihood that the segment will open an email including the same advertisement may be for a given period of time (e.g., 14 days).

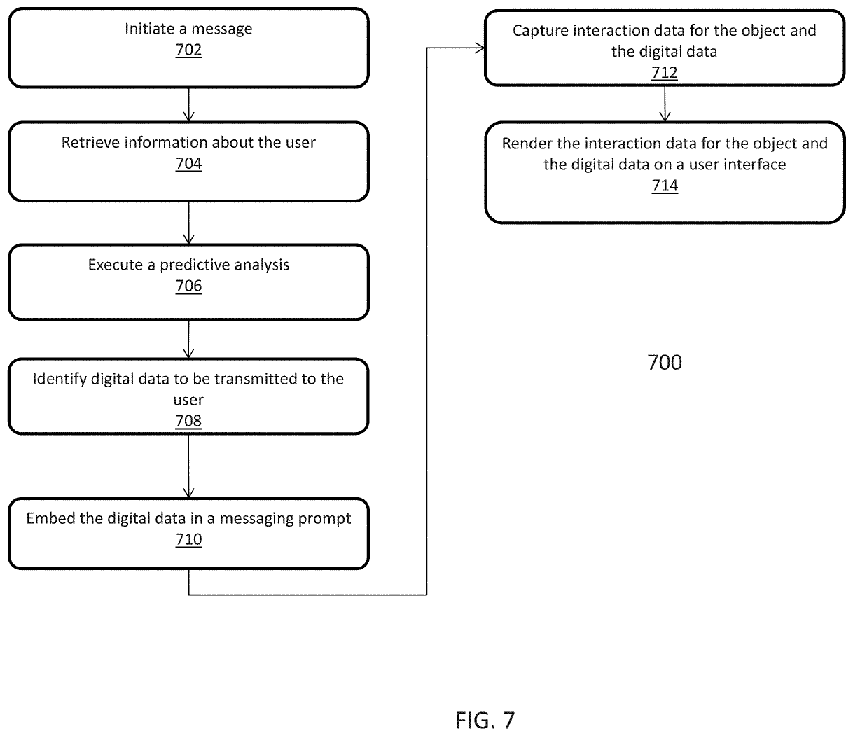

FIG. 7 is a flowchart illustrating a process of embedding digital data in a message and rendering analytics data about digital data, according to some embodiments. Method 700 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously, or in a different order than shown in FIG. 7, as will be understood by a person of ordinary skill in the art.

Method 700 shall be described with reference to FIG. 1. However, method 700 is not limited to that example embodiment.

In 702, a server 100 initiates a message intended to be transmitted to a user using a messaging service 104. Messaging service 104 may be a messaging platform configured to transmit messages such as e-mail, SMS, MMS, iMessage®, or various other messaging platforms as would be appreciated by a person of ordinary skill in the art. To initiate the message a user identifier may be input in the message. The user identifier may be a username, phone number, email address, screen name, or other type of identifier as would be appreciated by a person of ordinary skill in the art.

In 704, an analytics engine 102 retrieves information about the user. The analytics engine 102 may use the user identifier to retrieve information about the user from a database 140. The information may include user preferences about objects, products, vacations, activities, or the like.

In 706, the analytics engine 102 executes a predictive analysis using the information about the user. As an example, the predictive analysis may be based on one or more of the following predictive models: logic regression, random forests, decision trees, neural networks, or other type of predictive model as would be appreciated by a person of ordinary skill int the art.

In 708, the analytics engine 102 identifies digital data to be transmitted to the user based on the predictive analysis. The digital data may be digital content such as an image, video, text, or the like. The digital data may include an embedded tag associated with an object. The digital data may also be embedded with a link to a website that includes a link for a webpage including information about the object. The predictive analysis may determine that the user likely to interact with the digital data. As a non-limiting example, the digital data may be a particular advertisement, the object may be a product for sale, and the user may be a potential customer.

In 710, the analytics engine 102 automatically embeds the digital data in a messaging prompt to be transmitted to the user. The messaging prompt may be generated by the messaging service 104. As described above, the messaging prompt may be an email message, SMS message, MMS message, iMessage®, or other type of messaging prompt as would be appreciated by a person of ordinary skill in the art.

In 712, the server 100 captures interaction data for the object and the digital data. The interaction data may include clicks and impressions. For example, the user may select the link embedded in the advertisement received in the email and navigate to a website. The website may include links to e-commerce websites for the tagged products for sale.

In 714, the analytics engine 102 may render the interaction data for the object and the digital data on a user interface. The analytics engine 102 may generate analytics data based on the interaction data. The analytics engine 102 may depict the analytics data on a graph on the user interface. The user interface may be presented on the display of the client device 120.

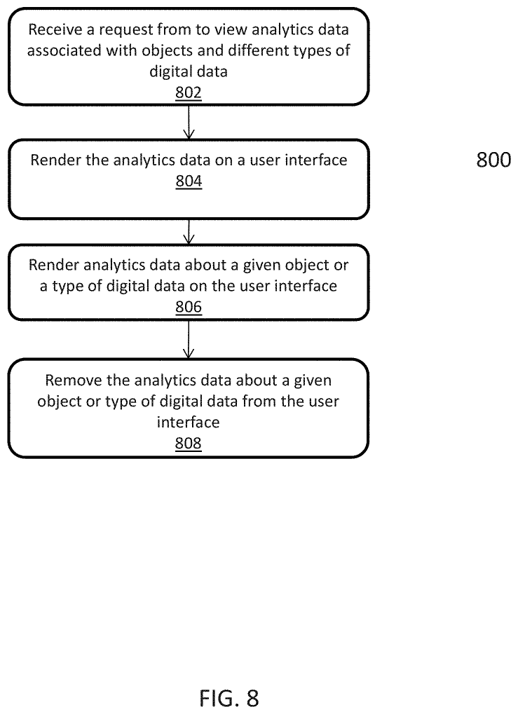

FIG. 8 is a flowchart illustrating a process of including and removing analytics data from the user interface for objects or digital data, according to some embodiments. Method 800 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously, or in a different order than shown in FIG. 8, as will be understood by a person of ordinary skill in the art.

Method 800 shall be described with reference to FIG. 1. However, method 800 is not limited to that example embodiment.

In 802, a server 100 receives a request from a client device 120 to view analytics data associated with objects and different types of digital data. As a non-limiting example, the digital data may be different advertisements. Each advertisement may be embedded with a tag for various products. The server 100 may capture interaction data (e.g., impressions and clicks) associated with the different advertisements and various products.

In 804, the analytics engine 102 renders the analytics data on a user interface. The analytics data may be depicted as a graph on the user interface. The different types of digital data and various products may be rendered on the user interface.

In 806, the analytics engine 102 renders analytics data about a given object or a type of digital data on the user interface, in response to receiving input on the user interface associated with a selection of the given object or type of digital data. As described above, the given object can be a product on sale and the digital data may be an advertisement.

In 808, the analytics engine 102 removes the analytics data about a given object or type of digital data from the user interface, in response to an input on the user interface associated with a de-selecting of the given object or type of digital data.

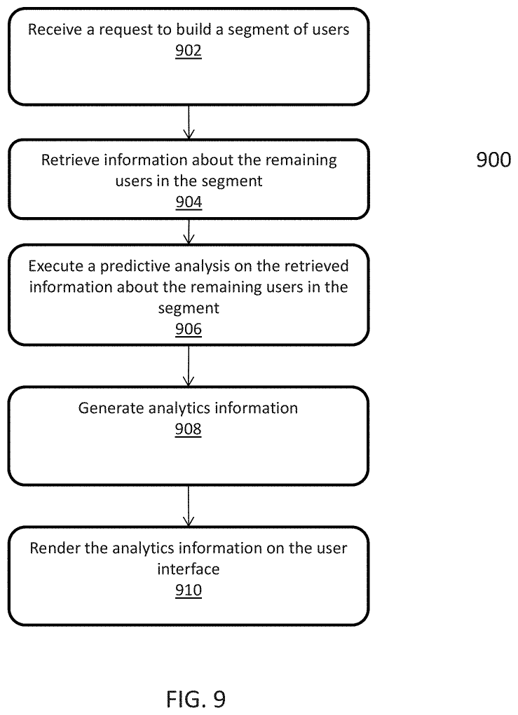

FIG. 9 is a flowchart illustrating the process for updating configuration settings during the execution of an application, according to some embodiments. Method 900 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously, or in a different order than shown in FIG. 9, as will be understood by a person of ordinary skill in the art.

Method 900 shall be described with reference to FIG. 1. However, method 800 is not limited to that example embodiment.

In 902, a server 100 receives a request to build a segment of users. The segment engine 106 may add or remove users from a segment in response to the request. The segment of users may be generated so that digital data (e.g., advertisement) of the same type can be transmitted to the segment of users.

In 904, in response, a request to add or remove users from the segment of users, the analytics engine 102 retrieves information about the remaining users in the segment. The analytics engine 102 may retrieve information such as user preferences about objects, products, activities, vacations, or the like.

In 906, the analytics engine 102 executes a predictive analysis on the retrieved information about the remaining users in the segment. The predictive analysis may determine the likelihood of the segment of users to interact with digital data of the same type.

In 908, the analytics engine 102 generates prediction information indicating the likelihood of the segment of users to interact with digital data of the same type. The analytics information may include a frequency analysis, email click prediction, email open prediction, email unsubscribe prediction, send time optimization, and content audit.

In 910, the analytics engine 102 may render the prediction information on the user interface. The user interface may be provided on the display of the client device.

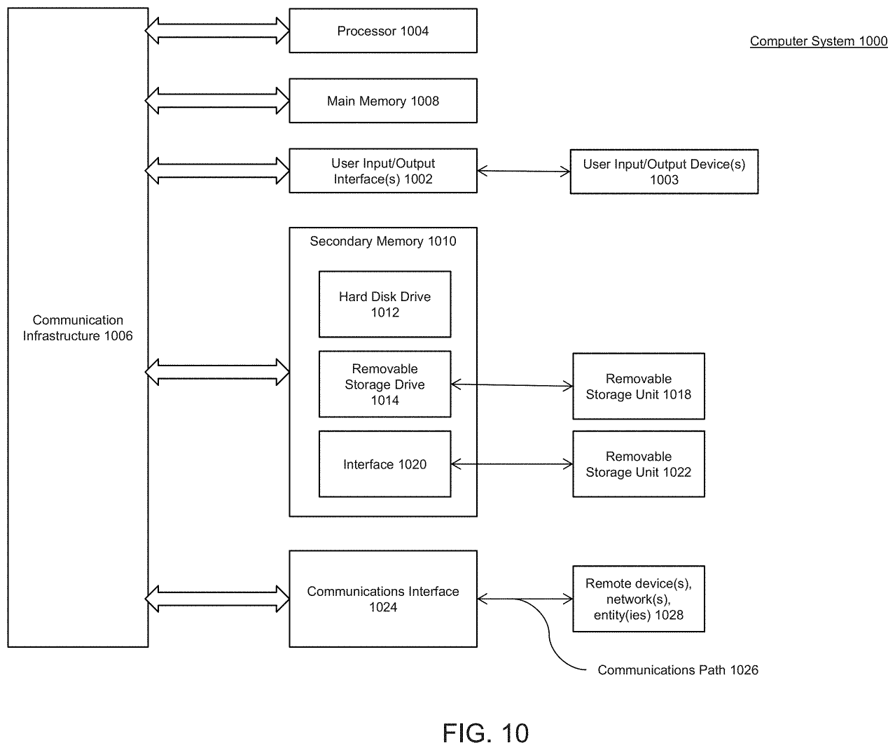

Various embodiments may be implemented, for example, using one or more well-known computer systems, such as computer system 1000 shown in FIG. 10. One or more computer systems 1000 may be used, for example, to implement any of the embodiments discussed herein, as well as combinations and sub-combinations thereof.

Computer system 1000 may include one or more processors (also called central processing units, or CPUs), such as a processor 1004. Processor 1004 may be connected to a communication infrastructure or bus 1006.

Computer system 1000 may also include user input/output device(s) 1003, such as monitors, keyboards, pointing devices, etc., which may communicate with communication infrastructure 1006 through user input/output interface(s) 1002.

One or more of processors 1004 may be a graphics processing unit (GPU). In some embodiments, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1000 may also include a main or primary memory 1008, such as random access memory (RAM). Main memory 1008 may include one or more levels of cache. Main memory 308 may have stored therein control logic (i.e., computer software) and/or data.

Computer system 1000 may also include one or more secondary storage devices or memory 1010. Secondary memory 1010 may include, for example, a hard disk drive 1012 and/or a removable storage device or drive 1014.

Removable storage drive 1014 may interact with a removable storage unit 1018. Removable storage unit 1018 may include a computer-usable or readable storage device having stored thereon computer software (control logic) and/or data. Removable storage unit 1018 may be program cartridge and cartridge interface (such as that found in video game devices), a removable memory chip (such as an EPROM or PROM) and associated socket, a memory stick and USB port, a memory card and associated memory card slot, and/or any other removable storage unit and associated interface. Removable storage drive 1014 may read from and/or write to removable storage unit 1018.

Secondary memory 1010 may include other means, devices, components, instrumentalities or other approaches for allowing computer programs and/or other instructions and/or data to be accessed by computer system 1000. Such means, devices, components, instrumentalities or other approaches may include, for example, a removable storage unit 1022 and an interface 1020. Examples of the removable storage unit 1022 and the interface 1020 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1000 may further include a communication or network interface 1024. Communication interface 1024 may enable computer system 1000 to communicate and interact with any combination of external devices, external networks, external entities, etc. (individually and collectively referenced by reference number 1028). For example, communication interface 1024 may allow computer system 1000 to communicate with external or remote devices 1028 over communications path 1026, which may be wired and/or wireless (or a combination thereof), and which may include any combination of LANs, WANs, the Internet, etc. Control logic and/or data may be transmitted to and from computer system 1000 via communication path 1026.

Computer system 1000 may also be any of a personal digital assistant (PDA), desktop workstation, laptop or notebook computer, netbook, tablet, smartphone, smartwatch or other wearable, appliance, part of the Internet-of-Things, and/or embedded system, to name a few non-limiting examples, or any combination thereof.

Computer system 1000 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1000 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1000, main memory 1008, secondary memory 1010, and removable storage units 1018 and 1022, as well as tangible articles of manufacture embodying any combination of the foregoing. Such control logic, when executed by one or more data processing devices (such as computer system 1000), may cause such data processing devices to operate as described herein.

The breadth and scope of the present disclosure should not be limited by any of the above-described exemplary embodiments but should be defined only in accordance with the following claims and their equivalents.

What is claimed is:

1. A computer-implemented method, comprising:
retrieving, by one or more computing devices, information about a user;
executing, by the one or more computing devices, a predictive analysis using the information about the user;
identifying, by the one or more computing devices, digital data to be transmitted to the user based on the executed predictive analysis, wherein the digital data includes an embedded tag associated with an object;
embedding, by the one or more computing devices, the digital data in a messaging prompt to be transmitted to the user;
identifying, by the one or more computing devices, the object associated with the embedded tag, using the embedded tag;
determining, by the one or more computing devices, interaction data for the object and the digital data; and
rendering, by the one or more computing devices, the interaction data for the object and the digital data on a user interface.

2. The method of claim 1, wherein the digital data includes other embedded tags associated with other objects.

3. The method of claim 2, further comprising:
rendering, by the one or more computing devices, the other objects on the user interface;
receiving, by the one or more computing devices, a selection of one or more of the other objects the user interface; and
rendering, by the one or more computing devices, interaction data for the one or more other objects on the user interface, in response to the selection of the one or more other objects.

4. The method of claim 1, wherein the interaction data for the object and the digital data is rendered on a graph.

5. The method of claim 1, wherein the digital data is embedded with a link to a website.

6. The method of claim 5, wherein the interaction data of the digital data includes a total number of selections of the link.

7. The method of claim 5, wherein the website includes information about the object.

8. A system comprising:
a memory; and
a processor communicatively coupled to the memory and configured to:
retrieve information about a user;
execute a predictive analysis using the information about the user;
identify digital data to be transmitted to the user based on the executed predictive analysis, wherein the digital data includes an embedded tag associated with an object;
embed the digital data in a messaging prompt to be transmitted to the user;
identify the object associated with the embedded tag, using the embedded tag;
determine interaction data for the object and the digital data; and
render the interaction data for the object and the digital data on a user interface.

9. The system of claim 8, wherein the embedded tag is associated with other objects.

10. The system of claim 9, wherein the processor is further configured to:
render the other objects on the user interface;
receive a selection of one or more of the other objects the user interface; and
render interaction data for the one or more other objects on the user interface, in response to the selection of the one or more other objects.

11. The system of claim 8, wherein the interaction data for the object and the digital data is rendered on a graph.

12. The system of claim 8, wherein the digital data is embedded with a link to a website.

13. The system of claim 12, wherein the interaction data of the digital data includes a total number of selections of the link.

14. The system of claim 12, wherein the web site includes information about the object.

15. A non-transitory computer-readable medium having instructions stored thereon that, when executed by at least one computing device, cause the at least one computing device to perform operations comprising:
retrieving information about a user;
executing a predictive analysis using the information about the user;
identifying digital data to be transmitted to the user based on the executed predictive analysis, wherein the digital data includes an embedded tag associated with an object;
embedding the digital data in a messaging prompt to be transmitted to the user;
identifying the object associated with the embedded tag, using the embedded tag;
determining interaction data for the object and the digital data; and
rendering the interaction data for the object and the digital data on a user interface.

16. The non-transitory computer-readable medium of claim 15, wherein the embedded tag is associated with other objects.

17. The non-transitory computer-readable medium of claim 16, the operations further comprising:
rendering the other objects on the user interface;
receiving a selection of one or more of the other objects the user interface; and
rendering interaction data for the one or more other objects on the user interface, in response to the selection of the one or more other objects.

18. The non-transitory computer-readable medium of claim 15, wherein the interaction data for the object and the digital data is rendered on a graph.

19. The non-transitory computer-readable medium of claim 15, wherein the digital data is embedded with a link to a web site.

20. The non-transitory computer-readable medium of claim 19, wherein the interaction data of the digital data includes a total number of selections of the link.
